(19) United States
(12) Patent Application Publication
(10) Pub. No.: US 2021/0076650 A1
(43) Pub. Date: Mar. 18, 2021

(54) Mannequin Fishing Lure

(71) Applicant: James Bingham, Atlanta, GA (US)

(72) Inventor: James Bingham, Atlanta, GA (US)

(21) Appl. No.: 16/884,767

(22) Filed: May 27, 2020

Related U.S. Application Data
(60) Provisional application No. 62/901,838, filed on Sep. 18, 2019.

(51) Int. Cl. A01K 85/01; A01K 85/16

(52) U.S. Cl. CPC A01K 85/01; A01K 85/16

(57) ABSTRACT

A fishing lure; the fishing lure includes a head segment, a body segment, a plurality of legs and a claw segment. The fishing lure simulates the appearance, movement, and sound of a crustacean, particularly a crawfish or a lobster, in order to provide a lifelike artificial bait to attract fish. The lure includes leg segments and claws can include multiple segments. A pivoting magnetic joint connects between the tail segment and body segment. Sometimes, the magnets on the body segment interact with the magnets on the tail segment to temporarily hook components in reference to each other.

### CROSS-REFERENCE TO RELATED APPLICATION

The present application is related to and claims priority to U.S. Provisional Patent Application No. 62/901,838 filed Sep. 18, 2019, which is incorporated by reference herein in its entirety.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### TECHNICAL FIELD

The present invention relates generally to the field of fishing accessories of existing art and more specifically relates to fishing lures.

### RELATED ART

Fishing bait is any substance used to attract fish. The bait is usually attached to the end of a fishing line and has assorted hook styles attached to the body designed to elicit a strike resulting in a hookset. Natural bait that is a common prey species is often used to attract a desired fish. Natural bait is effective due to its lifelike appearance, movements, and sound. However, individuals often struggle to catch fish using live bait. It can be difficult to keep the bait alive and it has to be frequently changed. Using artificial lures is often not successful because the lures are not realistic enough to attract the fish. Thus, a suitable solution is desired.

U.S. Pat. No. 8,793,924 to Timothy Richard Hughes relates to a Crawfish Fishing Lure. The described Crawfish Fishing Lure includes a body resembling the shape of a crawfish. The fishing lure includes a wire material and a flexible material connecting portions of a tail of the lure, and a passage through the body of the lure for receiving a fishing line such that an upward pulling of the fishing line passing through the passage causes a relative movement the portions of the tail in the downward action, and wherein the wire material operates to return the portions of the tail to their original position to generate a backward movement of the lure.

### SUMMARY OF THE INVENTION

In view of the foregoing disadvantages inherent in the known fishing lures art, the present disclosure provides a novel mannequin fishing lure or articulated crustacean fishing lure. The general purpose of the present disclosure, which will be described subsequently in greater detail, is to provide an mannequin fishing lure with the appearance, sound, and movement of a live crustacean.

A specialty fishing lure is disclosed herein. The fishing lure includes a head segment configured to simulate a head of a live crustacean. The head segment may further include a hook attached thereto, a first antenna attached about a first side, and a second antenna attached about a second side; the first antenna and the second antenna being configured to simulate antennae of the live crustacean.

A body segment may be attached to a first end of the head segment, the body segment being configured to simulate a body of the live crustacean. The body segment may be defined by an abdomen segment and a tail segment, the tail segment being pivotally attached to the abdomen segment such that the tail segment is able to move independent of the abdomen segment, and the movement of the tail segment may simulate movement of a tail of the live crustacean. Further, a plurality of legs may be attached about the body segment; the plurality of legs configured to simulate walking legs of the live crustacean.

In addition, a claw segment may be attached to a second end of the head segment, the claw segment including a first claw and a second claw. The first claw and the second claw may be configured to simulate claws of the live crustacean.

For purposes of summarizing the invention, certain aspects, advantages, and novel features of the invention have been described herein. It is to be understood that not necessarily all such advantages may be achieved in accordance with any one particular version of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification.

### BRIEF DESCRIPTION OF THE DRAWINGS

The figures which accompany the written portion of this specification illustrate versions and methods of use for the present disclosure, a mannequin fishing lure, constructed and operative according to the teachings of the present disclosure.

FIG. 1 is a side view of a fishing lure during an ‘in-use’ condition.

FIG. 2 is a side view of the fishing lure of FIG. 1.

FIG. 3 is a view a pivoting joint of the fishing lure of FIG. 1.

FIG. 4 is a perspective view of the fishing lure of FIG. 1.

The various versions of the present invention will hereinafter be described in conjunction with the appended drawings, wherein like designations denote like elements.

### DETAILED DESCRIPTION

As discussed above, versions of the present disclosure relate to fishing lures and more particularly to a mannequin fishing lure as used to improve artificial fishing baits and lures by providing a realistic looking fishing lure to assist everyday fishing enthusiasts and professional anglers in attracting more fish.

Generally disclosed is a fishing lure having the appearance of a crustacean, particularly a crawfish or a lobster. The lure may include segments such as head, body and tail joined together via pivoting/movable joints which allow the fishing lure to move realistically as a live crustacean would so as to attract fish. Further, the movement of the fishing lure may create a friction sound which mimics real sounds that the live crustacean makes when moving.

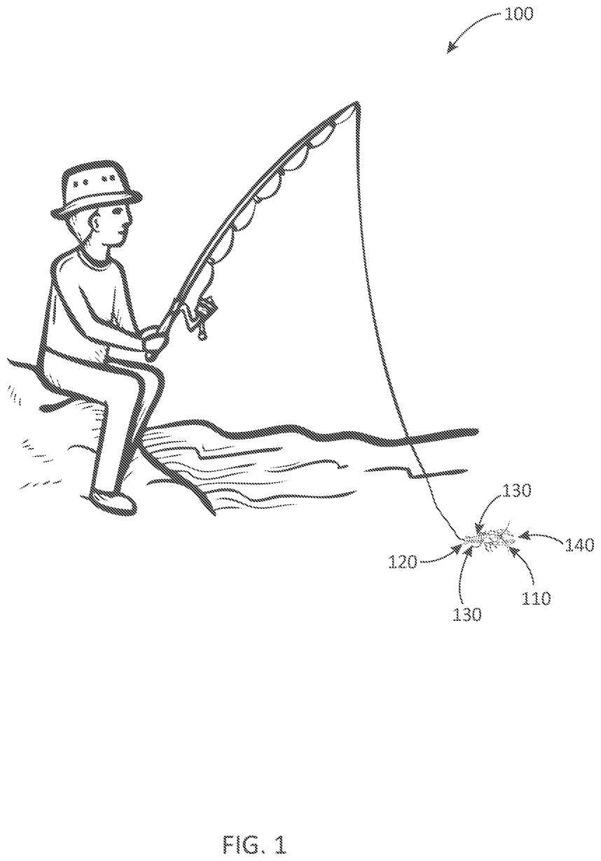

Referring now more specifically to the drawings by numerals of reference, there is shown in FIGS. 1-4, various views of a fishing lure 100.

FIG. 1 shows a fishing lure 100 during an ‘in-use’ condition, according to an version of the present disclosure. Here, the fishing lure 100 may be used to provide a lifelike artificial fishing lure to attract fish. As illustrated, the fishing lure 100 may include a head segment 110, a body segment 120, a plurality of legs 130 and a claw segment 140. The fishing lure 100 may resemble a live crustacean such as a lobster or a crawfish. In some versions, the head segment 110, the body segment 120 and the claw segment 140 may comprise a wood material, or a plastic material. However, other materials are contemplated. Preferably, the material is able to withstand repeated and prolonged fresh water and saltwater submersion without degradation.

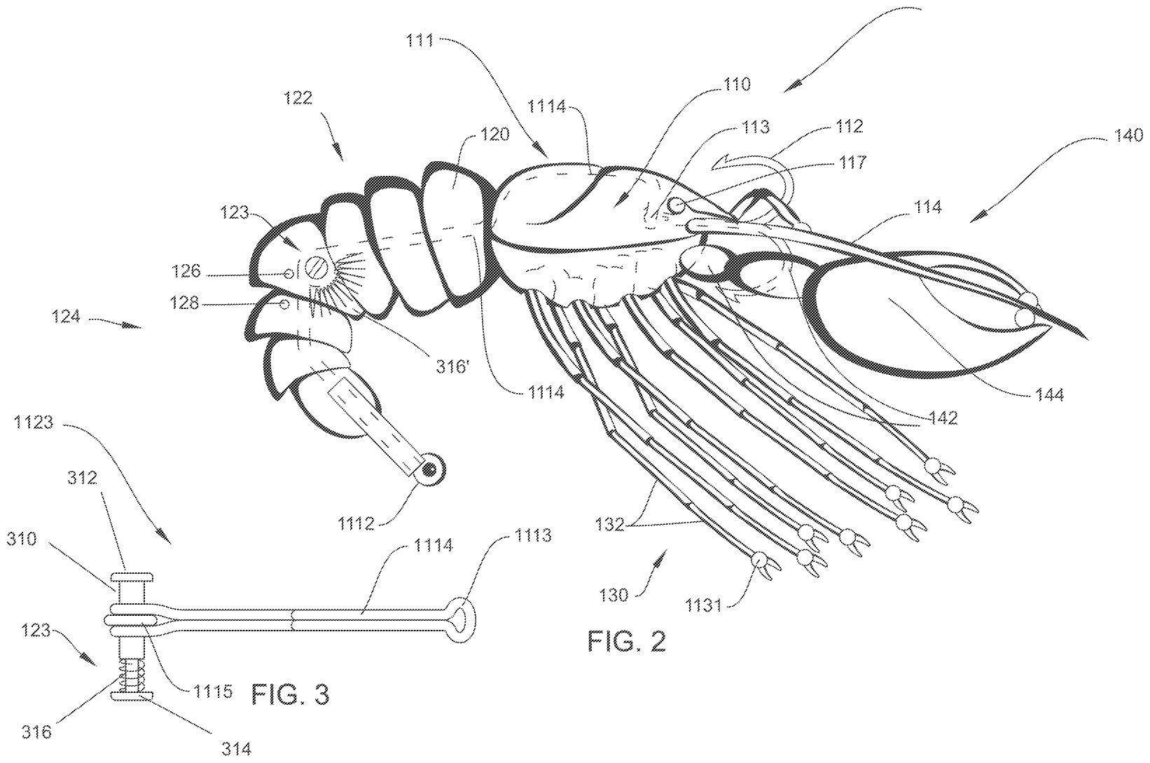

FIG. 2 shows the fishing lure 100 of FIG. 1, according to a version of the present disclosure. The head segment 110 may be configured to simulate a head of the live crustacean. As shown, the head segment 110 may include a hook 112 attached to and through the head segment 110, a first antenna 114 attached to a first side 111, and a second antenna (not shown) attached about a second side 113. Further, the head segment 110 may include a first eye 117 and a second configured to simulate eyes of the live crustacean. In one version, the first eye 117 and the second eye (not shown) may be metal screws. The first antenna 114 and the second antenna (not shown) may be configured to simulate antennae of the live crustacean. The first antenna 114 and the second antenna (not shown) may be made from wood or plastic. As above, other materials are contemplated. The materials contemplated should be able to withstand repeated and prolonged fresh water and saltwater submersion.

As shown, the claw segment 140 may be attached to a second end 113 of the head segment 110. The claw segment 140 may include a first claw 144 and a second claw (not shown); the first claw 144 and the second claw (not shown) simulate claws of the live crustacean. The first claw 144 and the second claw (not shown) may each split into at least two claw sections 142. As shown in this figure, the first claw 144 and the second claw (not shown) may split into three claw sections 142. The at least two claw sections 142 of the first claw 144 and the second claw (not shown) may move independently of each other, configured to simulate movement of the live crustacean. To achieve this, the at least two claw sections 142 of the first claw 144 and the second claw (not shown) may be movably connected via a flexible string 148 located in each of the first claw 144 and the second claw (not shown). For example, the flexible string may be threaded through each of the first claw 144 and the second claw (not shown) to connect each of the sections 142 together while maintaining moveability.

FIG. 3 is a view of a pivoting component 1123 comprising pivoting joint 123, which connects tail segment 124 two abdomen segment 122. As shown, the body segment 120 may be attached to a first end 111 of the head segment 110 and the body segment 120 may be configured to simulate a body of the live crustacean. In one version, the head segment 110 and the body segment 120 may be pivotally attached and movable independent of each other. In another version, the head segment 110 and the body segment 120 may be fixedly attached and unable to move independent of each other.

In some versions, the body segment 120 comprises an abdomen segment 122 and a tail segment 124. Component 1123 pivotally attaches the tail segment 124 to the abdomen segment 122 such that the tail segment 124 to move independently of the abdomen segment. The tail segment 124 may attached to the abdomen segment 122 via a pivoting joint 123.

As shown, the fishing lure 100 may include a rod 1114 (sometimes brass), preferably made from metal, running from the head segment 110 through the abdomen segment 122 to the tail segment 124, and the section between the abdomen segment 122 and the tail segment 124 may include the pivoting joint 123 connected to rod 1114. The pivoting joint 123 may allow the tail segment 124 to move in an upwards and downwards direction. In some versions, the pivoting joint 123 may include a spring 316 are spring 316′. Further, the pivoting joint 123 may include a first magnet 126, and the tail section 124 may include a second magnet 128. In some versions, the first magnet 126 and the second magnet 128 mate to lock the tail segment 124 in an extended position. In one example, when a fish is caught on the hook 112, the first magnet 126 and the second magnet 128 lock, and the tail segment 124, being in the extended position, gives a user more leverage to pull the fishing lure and fish out of the water.

Component 1123 comprises pivoting joint 123, which is made up of the binding post 310 connected to the button 312 and rod 1114. Rod 1114 ends at eye 1113, which connects into hook 112. Button 314 threads or connects into binding post 310 passing through spring 316. Spring 316 provides a spring bias to pivoting joint 123.

Movement of the tail segment 124 may simulate movement of a tail of a live crustacean. Further, the movement of the tail segment 124 may cause the tail segment 124 to make a sound that simulates live crustacean sounds. Tail segment 124 rubbing against the abdomen segment 122, or pivoting joint 123 movement may create the sound. Movement may be actuated by the user, or may be actuated by natural movement of water around the fishing lure 100.

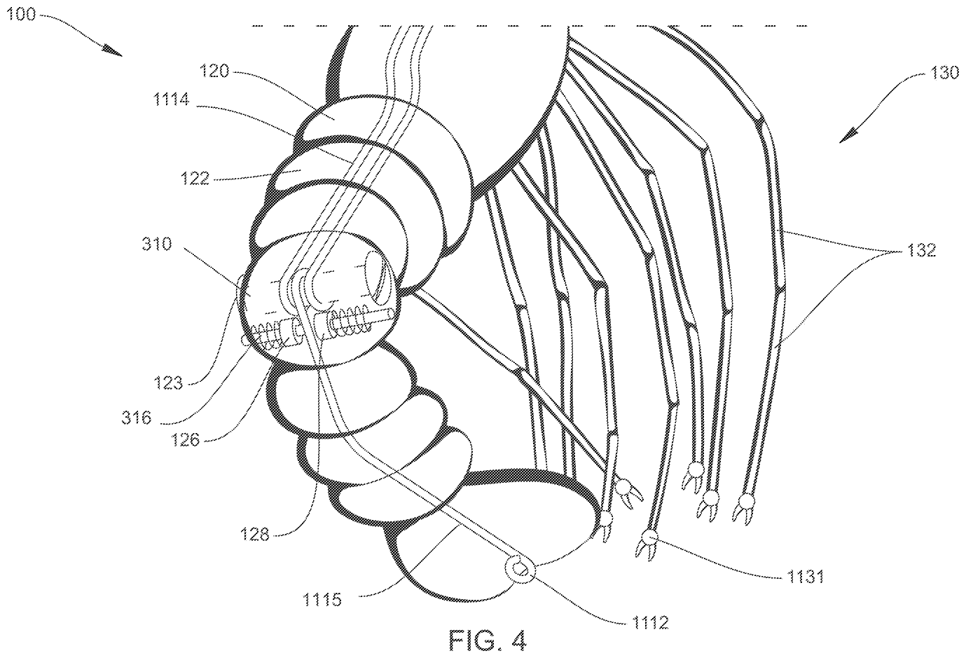

FIG. 4 shows the members discussed above. It also shows ball bearings 1131, which as above, can create crustacean noise in use. Binding post 310 connects to rod 1114 and secondary rod 1115 at pivoting joint 123. Attachment eye 1112 sits at an end of rod 1115. In this view, the figure shows magnet 126 and magnet 128 biased with spring 316.

The plurality of legs 130 may each be split into at least two leg sections 132. The at least two leg sections 132 of each of the plurality of legs 130 may be movable independent of each other, configured to simulate movement of the live crustacean. Similar to the at least two claw sections 142, the at least two leg sections 132 of each of the plurality of legs 130 may be movably connected via the flexible string located in each of the plurality of legs 130. As above with the at two claw sections 142, the flexible string may be threaded through each of the plurality of legs 130 to connect each of the sections 132 of each leg together while maintaining moveability. Ball bearings located in the head section 110 may hold the plurality of legs 130. Further, ball-bearing, such as steel ball bearings 1131, may be located at an end of any one or all of the plurality of legs 130, pincers, or other appendages to reflect light or to make noise to attract the attention of a fish. In some versions, bearings 1131 are optional.

The versions of the invention described herein are exemplary and numerous modifications, variations, and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new:

1. A fishing lure comprising:
a head segment configured to simulate a head of a live crustacean, the head segment including:
a hook;
a first antenna attached about a first side of the segment; and
a second antenna attached about a second side of the segment,
wherein the first antenna and the second antenna are configured to simulate live crustacean antennae;
a body segment attached to a first end of the head segment configured to simulate a live crustacean body, the body segment having an abdomen segment pivotally attached to a tail segment such that tail-segment motion is independent of abdomen segment motion, wherein movement of the tail segment simulates live crustacean-tail movement;
a plurality of legs attached about the head segment configured to simulate live crustacean walking legs; and
a claw segment attached to a second end of the head segment including first and second claws configured to simulate live crustacean claws.

2. The fishing lure of claim 1, wherein tail-segment movement generates a sound configured to simulate live-crustacean movement sound.

3. The fishing lure of claim 1, wherein the tail segment attaches to the abdomen segment with a pivoting joint.

4. The fishing lure of claim 1, wherein the pivoting joint includes a first magnet.

5. The fishing lure of claim 1, wherein the tail segment includes a second magnet, and wherein the first magnet and the second magnet lock the tail segment in an extended position.

6. The fishing lure of claim 1, wherein the first and second claws are each split into at least two claw sections.

7. The fishing lure of claim 6, wherein the at least two claw sections are movable independent of each other, configured to simulate live-crustacean movement.

8. The fishing lure of claim 7, wherein the at least two claw sections are movably connected with a flexible string.

9. The fishing lure of claim 1, wherein the head segment and the body segment are pivotally attached to and movable independently of each other.

10. The fishing lure of claim 1, wherein the head segment and the body segment are fixedly attached.

11. The fishing lure of claim 1, wherein each of the plurality of legs is divided into at least two leg sections.

12. The fishing lure of claim 11, wherein the at least two leg sections are movable independent of each other and configured to simulate live crustacean movement.

13. The fishing lure of claim 12, wherein the at least two leg sections are movably connected with a flexible string.

14. The fishing lure of claim 1, wherein the head segment, the body segment, and the claw segment comprise wood.

15. The fishing lure of claim 1, wherein the head segment, the body segment, and the claw segment comprise a plastic.

16. The fishing lure of claim 14, wherein the first antenna, the second antenna, and the plurality of legs comprise wood.

17. The fishing lure of claim 15, wherein the first antenna, the second antenna, and the plurality of legs comprise the plastic.

18. The fishing lure of claim 1, wherein the head segment includes a first and second eyes configured to simulate live crustacean eyes.

19. A fishing lure comprising:
a head segment configured to simulate a head of a live crustacean, the head segment including:
a hook;
a first antenna attached about a first side of the segment;
and
a second antenna attached about a second side of the segment,
wherein the first antenna and the second antenna are configured to simulate live crustacean antennae;
a body segment attached to a first end of the head segment configured to simulate a live crustacean body, the body segment having an abdomen segment pivotally attached to a tail segment such that tail-segment motion is independent of abdomen segment motion, wherein movement of the tail segment simulates live crustacean-tail movement and wherein tail movement causes the tail segment to rub against the abdomen segment, generating a sound that simulates live-crustacean-movement sound;
a plurality of legs attached about the head segment, the plurality of legs configured to simulate live crustacean walking legs;
and
a claw segment attached to a second end of the head segment, the claw segment including a first claw and a second claw configured to simulate live crustacean claws.

20. A fishing lure comprising:
a head segment configured to simulate a head of live crustacean, the head segment including:
a hook;
a first antenna attached about a first side of the segment; and
a second antenna attached about a second side of the segment,
wherein the first antenna and the second antenna are configured to simulate live crustacean antennae;
a body segment attached to a first end of the head segment configured to simulate a live crustacean body, the body segment having an abdomen segment pivotally attached to a tail segment such that tail-segment motion is independent of abdomen segment motion, wherein movement of the tail segment simulates live crustacean-tail movement and wherein tail movement causes the tail segment to rub against the abdomen segment, generating a sound that simulates a live-crustacean-movement sound;
two independently movable leg sections comprising a plurality of legs attached about the head segment configured to simulate live crustacean walking legs, wherein the at least two leg sections are movably connected with a flexible string;
and
a claw segment attached to a second end of the head segment including first and second claws configured to simulate live crustacean claws, the first claw and the second claw each being split into at least two independently movable claw sections, and configured to simulate live crustacean movement, wherein the at least two claw sections of the first claw and the second claw are movably connected with a flexible string.
